(19) United States
(12) Patent Application Publication
(10) Pub. No.: US 2024/0305840 A1
(43) Pub. Date: Sep. 12, 2024

(54) CONTEXT-BASED DYNAMIC ZOOMING

(71) Applicant: INTERNATIONAL BUSINESS MACHINES CORPORATION, ARMONK, NY (US)

(72) Inventors: Prattyush Mangal, London (GB); Anjali Srivastava, Kanpur (IN)

(21) Appl. No.: 18/181,762

(22) Filed: Mar. 10, 2023

(51) Int. Cl. H04N 21/2343; G06F 40/30; G06V 10/25; G06V 10/26; G06V 20/40; H04N 21/234; H04N 21/472

(52) U.S. Cl. CPC H04N 21/234345; G06F 40/30; G06V 10/25; G06V 10/267; G06V 20/41; H04N 21/23418; H04N 21/47205

(57) ABSTRACT

A method, computer system, and a computer program product for context-based dynamic zooming is provided. The present invention may include determining a context of a text block using natural language processing (NLP). The present invention may include identifying a clip of a video content synced with the text block, wherein the clip includes at least one frame of the video content. The present invention may include selecting a most relevant region of the at least one frame based on the context of the text block. The present invention may include storing the most relevant region of the at least one frame of the video content as a zoom region of the at least one frame. The present invention may include in response to displaying the at least one frame of the video content, dynamically magnifying the zoom region of the at least one frame of the video content.

### BACKGROUND

The present invention relates generally to the field of computing, and more particularly to user accessibility technology.

Individuals with visual impairments may struggle to enjoy a standard television and movie viewing experience. These individuals may need to take extra efforts, such as, straining their vision, wearing eye glasses, and/or viewing a screen from a closer distance, to see the actual visual contents of a video. However, even with these efforts, some contextually relevant visual details in the video may be missed.

### SUMMARY

Embodiments of the present invention disclose a method, computer system, and a computer program product for context-based dynamic zooming. The present invention may include determining a context of a text block using natural language processing (NLP). The present invention may include identifying a clip of a video content synced with the text block, wherein the clip includes at least one frame of the video content. The present invention may include selecting a most relevant region of the at least one frame based on the context of the text block. The present invention may include storing the most relevant region of the at least one frame of the video content as a zoom region of the at least one frame. The present invention may include in response to displaying the at least one frame of the video content, dynamically magnifying the zoom region of the at least one frame of the video content.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a video enhancement environment according to at least one embodiment;

FIG. 3 is an operational flowchart illustrating a process for context-based dynamic zooming according to at least one embodiment; and

FIG. 4 is a schematic block diagram of an exemplary implementation of the process for context-based dynamic zooming according to at least one embodiment.

### DETAILED DESCRIPTION

The following described exemplary embodiments provide a system, method, and computer program product for context-based dynamic zooming of video content. As such, the present embodiment has the capacity to improve the technical field of user accessibility by analyzing the text of a scene from a script and the video frames associated with that scene to determine the most relevant regions of action taking place in the video frame for dynamically zooming into those most relevant regions. More specifically, a context-based dynamic zoom (“CBDZ”) program may determine a context of a text block using natural language processing (NLP). Then, the CBDZ program may identify a frame of a video content associated with the text block. Then, the CBDZ program may select a most relevant region of the frame of the video content based on the context of the text block. Next, the CBDZ program may store the most relevant region of the frame of the video content as a zoom region of the frame. Thereafter, in response to displaying the frame of the video content, the CBDZ program may dynamically magnify the zoom region of the frame of the video content.

As described previously, individuals with visual impairments may struggle to enjoy a standard television and movie viewing experience. These individuals may need to take extra efforts, such as, straining their vision, wearing eye glasses, and/or viewing a screen from a closer distance, to see the actual visual contents of a video. However, even with these efforts, some contextually relevant visual details in the video may be missed.

Therefore, it may be advantageous to, among other things, provide a way to derive context from a text block (e.g., scene) of a script or transcript, using NLP, and correlate the action in a video frame to find regions of contextual relevance through image segmentation.

According to one embodiment, the CBDZ program may receive a first input of a script or transcript (e.g., electronic text document) and a second input of a video content associated with the script or transcript. In one embodiment, the CBDZ program may identify and analyze one or more scenes from the script.

According to one embodiment, the CBDZ program may analyze each scene using NLP (e.g., semantic analysis techniques)to understand the context of the scene and determine the important elements of the scene. In one embodiment, the CBDZ program may tag the text of each scene with classifiers/tags that identify what is important in that scene. In one embodiment, each tag may be assigned a relevance value based on occurrence/importance in the script of the scene.

According to one embodiment, the CBDZ program may identify frames in the video content that correspond to the scene being analyzed. In one embodiment, the CBDZ program may perform image segmentation on the frames corresponding to the scene to find regions of interest (ROIs) in the frames. In one embodiment, the tags obtained from the script analysis may be provided to the image segmentation model to indicate specific characteristics to search for in the frames. In one embodiment, the ROIs obtained by the CBDZ program may be correlated with the relevance values of the tags associated with the ROIs. In one embodiment, the CBDZ program may select the ROIs corresponding to the tags of highest relevance values as the highest relevance ROIs in the frame. Then, the CBDZ program may find a greatest common area from all the selected ROIs (e.g., highest relevance ROIs) to form a most relevant region per frame. In one embodiment, coordinates of the most relevant regions may be retrieved and stored as zoom regions.

According to one embodiment, the CBDZ program may store one or more zoon regions per frame for the whole video. In one embodiment, the CBDZ program may broadcast the zoom region information with video content (e.g., including audio), as well as various other contents (e.g., subtitle content, audio description content).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

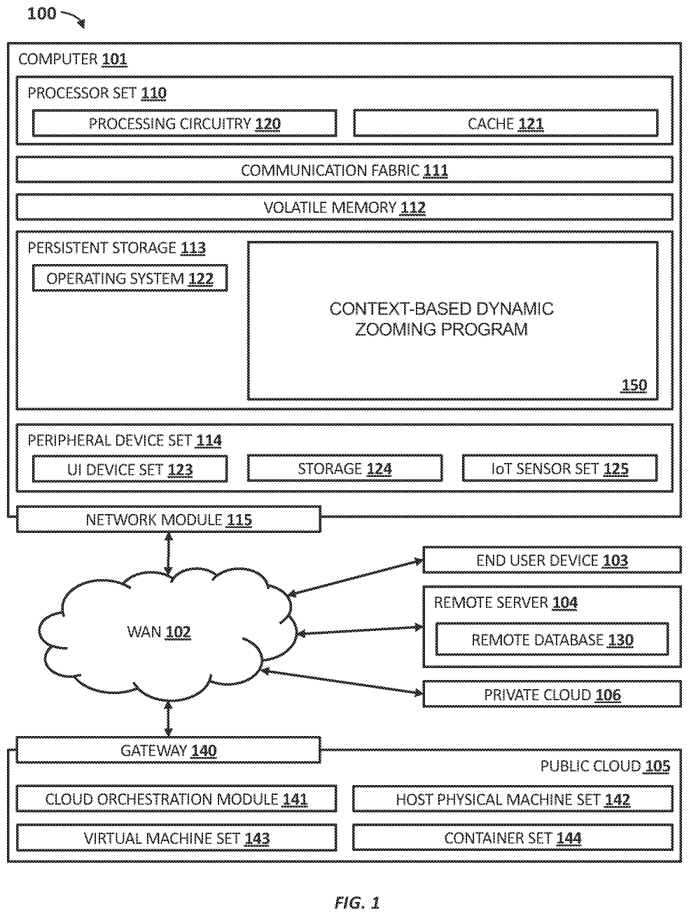

Referring to FIG. 1, a computing environment 100 according to at least one embodiment is depicted. Computing environment 100 contains an example of an environment for the execution of at least some of the computer code involved in performing the inventive methods, such as a context-based dynamic zooming (CBDZ) program 150. In addition to the CBDZ program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the CBDZ program 150, as identified above), peripheral device set 114 (including user interface (UI)), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, CBDZ program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The CBDZ program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth—based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

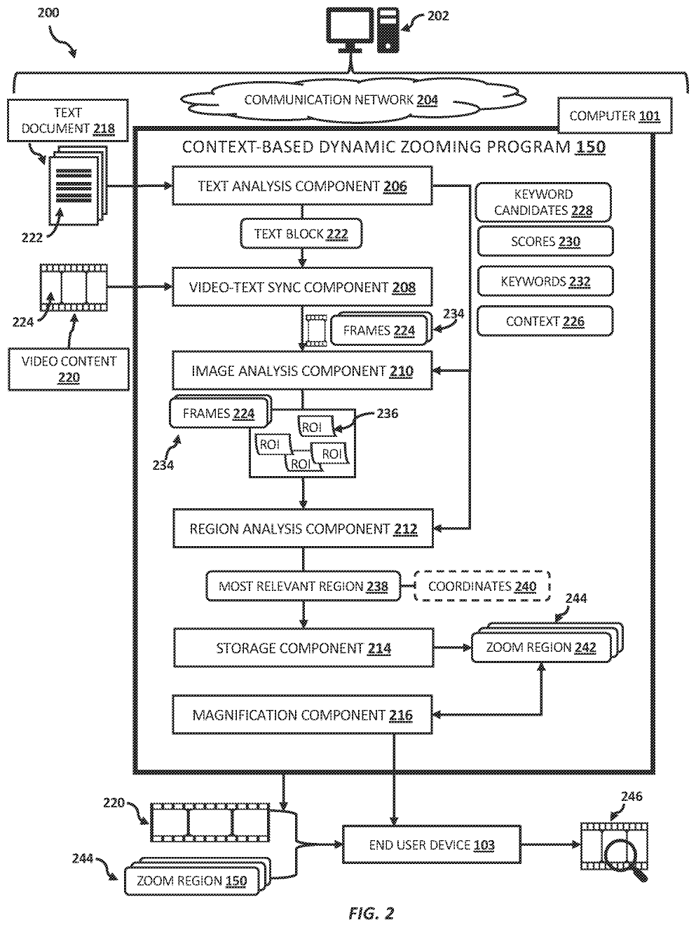

According to the present embodiment, a user using any combination of a computer 101, end user device (EUD) 103, remote server 104, public cloud 105, and private cloud 106 may implement the context-based dynamic zoom (CBDZ) program 150 to derive context from a text block of a script (e.g., scene) or transcript, using NLP, and correlate the action in a video frame to find regions of contextual relevance through image segmentation. Embodiments of the present disclosure are explained in more detail below with respect to FIGS. 2 to 4.

Referring now to FIG. 2, a schematic block diagram of a video enhancement environment 200 according to at least one embodiment is depicted. According to one embodiment, the video enhancement environment 200 may include a computer system 202 having a tangible storage device and a processor that is enabled to run the CBDZ program 150.

Generally, the computer system 202 may be enabled by the CBDZ program 150 to define a viewing pattern (e.g., zooming instructions) for a video content, which may be used to zoom into the most relevant regions of the video content. In one embodiment, the CBDZ program 150 may define the viewing pattern based on determining a context of the video content from analyzing a text associated with the video content.

According to one embodiment, the computer system 202 may include one or more components (e.g., computer 101; end user device (EUD) 103; WAN 102) of the computer environment 100 described above with reference to FIG. 1. In one embodiment, the computer system 202 may include one or more computers (e.g., computer 101; EUD 103) which may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, and/or querying a database.

According to one embodiment, the computer system 202 may operate in a cloud computing service model, such as Software as a Service (SaaS), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

In one embodiment, the CBDZ program 150 may include a single computer program or multiple program modules or sets of instructions being executed by the processor of the computer system 202 (e.g., computer 101; EUD 103). In one embodiment, the CBDZ program 150 may include routines, objects, components, units, logic, data structures, and actions that may perform particular tasks or implement particular abstract data types. In one embodiment, the CBDZ program 150 may be practiced in distributed cloud computing environments where tasks may be performed by local and/or remote processing devices which may be linked through a communication network 204. In at least one embodiment, the CBDZ program 150 (e.g., the various modules) may be executed on a single computing device (e.g., computer 101 or EUD 103).

According to one embodiment, the various components of computer system 202 may be communicatively coupled via the communication network 204. The communication network 204 may include various types of communication networks, such as the wide area network (WAN) 102, described with reference to FIG. 1. In some embodiments, the WAN may be replaced and/or supplemented by a local area network (LAN), a telecommunication network (e.g., 3G, 4G, 5G), a wireless network, a public switched network and/or a satellite network.

According to one embodiment, the CBDZ program 150 may include various components, such as, a text analysis component 206, a video-text sync component 208, an image analysis component 210, a region analysis component 212, a storage component 214, and a magnification component 216.

According to one embodiment, the CBDZ program 150 may receive a text document 218 and a video content 220 associated with the text document 218. In one embodiment, the text document 218 may represent an electronic text data of a pre-planned script of the video content 220 and/or an after-the-fact transcription generated from the video content 220 (e.g., via audio-to-text transcription). The text document 218 may include one or more text blocks 222. In one embodiment, the text block 222 may include a scene, a page, a paragraph, a line, and/or any other subset or portion of the text document 218. The video content 220 may include audio data, as well as one or more frames 224 which sequentially form the video content 220.

According to one embodiment, the CBDZ program 150 may implement the text analysis component 206 to analyze the text document 218 using natural language processing (NLP). In one embodiment, the text analysis component 206 may split the text document 218 into the various text blocks 222 and analyze each text block 222 using NLP (e.g., semantic analysis) to determine a context 226 of the text block 222. In one embodiment, the context 226 of the text block 222 may provide, for the CBDZ program 150, an understanding of the semantics (e.g., meaning) and/or important aspects described in the text block 222. In one embodiment, the context 226 may indicate a summary of the text block 222 and/or highlight important focus areas of the text block 222.

According to one embodiment, the text analysis component 206 may determine the context 226 of the text block 222 by implementing keyword extraction to identify one or more terms that represent the most relevant information (e.g., subjects, actions, objects) contained in the text block 222. In one embodiment, the text analysis component 206 may perform keyword extraction to extract one or more keyword candidates 228 (e.g., set of keyword candidates) from the text block 222. The keyword candidates 228 may include single terms or multiple terms (e.g., key phrases). Then, the text analysis component 206 may assign a relevance score 230 to each keyword candidate 228. In one embodiment, the relevance score 230 may indicate a relative importance of each keyword candidate 228 to understanding the context 226 of the text block 222. In one embodiment, the text analysis component 206 may rank the set of keyword candidates 228 based on the relevance score 230 assigned respectively to each keyword candidate 228. In one embodiment, the text analysis component 206 may select a subset of keywords 232 (e.g., single terms or multiple terms) from the set of keyword candidates 228. The subset of keywords 232 may include any number of keywords 232 that have the highest ranking set of the relevance scores 230. For example, if there are 10 keyword candidates 228, each having the assigned relevance score 230, the text analysis component 206 may select the top 5 keywords 232, where the top 5 keywords 232 includes the top 5 relevance scores 230 (e.g., highest ranking set of the relevance scores 230) from the set of relevance scores 230 assigned to the keyword candidates 228. In one embodiment, the CBDZ program 150 may determine that the selected subset of keywords 232 indicates the context 226 of the text block 222. In other words, the selected subset of keywords 232 may represent the most relevant information (e.g., subjects, actions, objects) contained in the text block 222.

According to one embodiment, the video-text sync component 208 may receive the text block 222 being analyzed by the text analysis component 206 and identify the one or more frames 224 of the video content 220 that corresponds to the text block 222. In one embodiment, the video-text sync component 208 may identify a clip 234 of the video content 220 that corresponds to the text block 222, where the clip 234 of the video content 220 includes multiple frames 224. In one embodiment, the video-text sync component 208 may match the text of the text block 222 with the audio data (e.g., dialogue) of the video content 220 to identify the clip 234 (e.g., set of frames 224) that is synced to the text block 222.

According to one embodiment, the CBDZ program 150 may implement the image analysis component 210 (e.g., using computer vision techniques) to detect one or more regions of interest (ROIs) 236 (e.g., set of ROIs) in the one or more frames 224 of the video content 220 synched to the text block 222. In one embodiment, the image analysis component 210 may detect the ROIs 236 in a single frame 224 and/or jointly (e.g., simultaneously; concurrently) detect the ROIs 236 across the set of frame 224 of the clip 234 synched to the text block 222.

According to one embodiment, the CBDZ program 150 may implement the region analysis component 212 to receive and compare the set of ROIs 236 detected in the frames 224 and the context 226 of the text block 222 determined by the text analysis component 206. Based on the comparison, the region analysis component 212 may determine a most relevant region 238 in each frame 224. In one embodiment, the most relevant region 238 of the frame 224 may visually represent one or more characteristics of the context 226 of the text block 222. In one embodiment, the most relevant region 238 of the frame 224 may include a region that includes the context 226 of the text block 222 in the frame 224.

According to at least one embodiment, the CBDZ program 150 may provide the image analysis component 210 with the keywords candidates 228 as a specification of characteristics to look for when searching for the ROIs 236 in the frames 224. For example, if one of the extracted (e.g., tagged) keyword candidates 228 is “black blob,” the CBDZ program 150 may provide the tag “black blob” to the image analysis component 210 as an instruction to search for an ROI 236 including a group of black pixels in the frame 224.

According to one embodiment, the region analysis component 212 may determine which keyword candidates 228 corresponds to each of the ROIs 236 detected by the image analysis component 210. Then, the region analysis component 212 may correlate (e.g., assign; link) each of the ROIs 236 with the relevance scores 230 of the keyword candidates 228 that corresponds to the ROI 236. For example, the region analysis component 212 may determine that a first ROI 236 detected by the image analysis component 210 corresponds to a first keyword candidate 228, which has the assigned relevance score 230 of “0.61”. As such, the region analysis component 212 may correlate the first ROI 236 with the relevance score 230 of “0.61”.

According to one embodiment, the region analysis component 212 may select a subset of ROIs 236 corresponding to the subset of keywords 232. Since the subset of keywords 232 includes the highest ranking set of the relevance scores 230, the region analysis component 212 may correlate the subset of the ROIs 236 corresponding to the subset of keywords 232 with the highest ranking set of the relevance scores 230. In other words, the region analysis component 212 may filter the set of ROIs 236 to select the subset of the ROIs 236 corresponding to the subset of keywords 232 having the highest ranking set of the relevance scores 230 (e.g., extracted tags of highest relevance in the text block 222).

According to one embodiment, the CBDZ program 150 may provide the image analysis component 210 with only the subset of keywords 232 (e.g., instead of all the keyword candidates 228) as a specification of characteristics to look for when searching for the ROIs 236 in the frames 224. As such, the ROIs 236 detected by the image analysis component 210, based on instructions to search for characteristics of the subset of keywords 232, may be correlated with the highest ranking set of the relevance scores 230 assigned to the subset of keywords 232.

According to one embodiment, once the region analysis component 212 selects the subset of ROIs 236 associated with the highest ranking set of the relevance scores 230, the region analysis component 212 may determine a greatest common area in the frame 224 that captures the subset of ROIs 236. In one embodiment, the greatest common area in the frame 224 may include an area in the frame 224 that includes the subset of ROIs 236 associated with the highest ranking set of the relevance scores 230. In one embodiment, the region analysis component 212 may identify the determined greatest common area in the frame 224 as the most relevant region 238 of the frame 224. In one embodiment, the most relevant region 238 may include a majority or all of the subset of ROIs 236 associated with the highest ranking set of the relevance scores 230. In one embodiment, the region analysis component 212 may determine one or more coordinates 240 of the most relevant region 238 in the frame 224. In one embodiment, the coordinates 240 may provide a bounding box to locate the most relevant region 238 in the frame 224.

According to one embodiment, the CBDZ program 150 may implement the storage component 214 to store (e.g., register; save) the most relevant region 238 (e.g., coordinates 240 thereof) as a zoom region 242 of the frame 224. In one embodiment, the storage component 214 may store the zoom region 242 per frame 224 for the entire video content 220. In some embodiments, the storage component 214 may store the zoom region 242 per clip 234 for the entire video content 220 such that each frame 224 in the clip 234 may include the same zoom region 242.

In one embodiment, the storage component 214 may store a respective most relevant region 238 (e.g., coordinates 240) of the plurality of frames 224 of the video content 220 as a set of zooming instructions 244 for the video content 220. The set of zooming instructions 244 may indicate a respective zoom region 242 of the plurality of frames 224 of the video content 220.

According to one embodiment, the CBDZ program 150 may transmit (e.g., broadcast) the video content 220 with the set of zooming instructions 244 to the end user device (EUD) 103. In one embodiment, the CBDZ program 150 may detect a selection of a zoom-to-context (e.g., zoom to action) option on the EUD 103 and initiate the set of zooming instructions 244 for the video content 220 in response to detecting the selection. Thereafter, the CBDZ program 150 may implement the magnification component 216 to output a dynamically zoomed video content 246 from the EUD 103. In one embodiment, the dynamically zoomed video content 246 detects the specific frame 224 of the video content 220 being displayed on the EUD 103 and dynamically magnifies (e.g., zoom into) the respective zoom region 242 of the detected specific frame 224 of the video content 220. In one embodiment, the dynamic magnification or zooming of the zoom regions 242 may crop out other areas of the frame 224 to enable the user to focus on the most relevant region 238 of the frame 224. In one embodiment, the dynamic magnification or zooming of the zoom regions 242 may be provided in real-time, for example, as the detected specific frame 224 of the video content 220 is being displayed on the EUD 103.

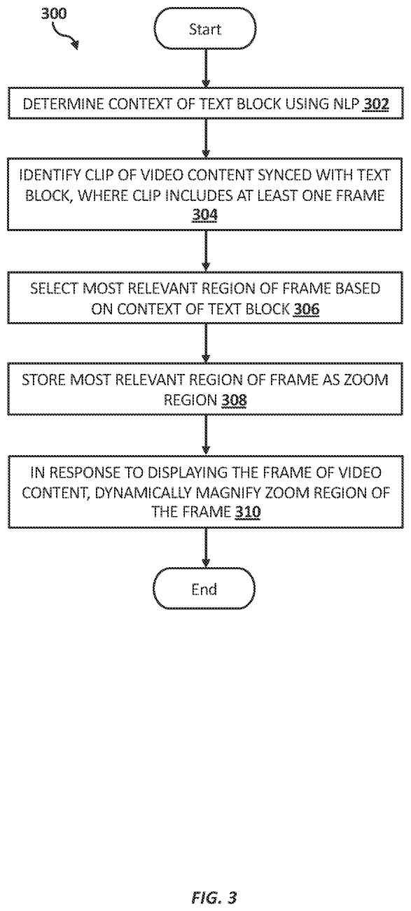

Referring now to FIG. 3, an operational flowchart illustrating an exemplary process 300 used by the CBDZ program 150 according to at least one embodiment is depicted. FIG. 3 provides a general description of process 300 with reference to the detailed description of the video enhancement environment 200 (FIG. 2).

At 302, a context of a text block is determined using natural language processing (NLP). According to one embodiment, the CBDZ program 150 may receive a text document (e.g., pre-planned script and/or an after-the-fact transcription) and a video content associated with the text document. In one embodiment, the CBDZ program 150 may split the text document into one or more text blocks and analyze each text block using NLP (e.g., semantic analysis) to determine the context of the text block, as described previously with reference to FIG. 2.

According to one embodiment, the CBDZ program 150 may determine the context of the text block by implementing keyword extraction, as described previously with reference to FIG. 2. In one embodiment, the CBDZ program 150 may implement the keyword extraction process to extract a set of keyword candidates from the text block. In one embodiment, the CBDZ program 150 may rank the set of keyword candidates based on a relevance score assigned to each keyword candidate, respectively, of the set of keyword candidates. In one embodiment, the relevance score assigned to each keyword candidate may indicate a relative importance of each keyword candidate to understanding the context of the text block. Then, the CBDZ program 150 may select a subset of keywords from the set of keyword candidates based on determining that the subset of keywords includes relevance scores that are part of the highest ranking set of the relevance scores. In one embodiment, given the high relevance scores of the subset of keywords, the CBDZ program 150 may determine that the subset of keywords indicates the context of the text block in terms of the most relevant information (e.g., subjects, actions, objects) contained in the text block.

Then at 304, a clip of a video content synced to the text block is identified, where the clip includes at least one frame of the video content. According to one embodiment, the CBDZ program 150 may match the text of the text block with the audio data (e.g., dialogue) of the video content to identify the clip of the video content that is synced to the text block, as described previously with reference to FIG. 2. In one embodiment, the clip of the video content may include one or more frames of the video content.

Then at 306, a most relevant region of the at least one frame is selected based on the context of the text block. In one embodiment, the CBDZ program 150 may use image segmentation to detect one or more regions of interest (ROIs) in the at least one frame of the video content. In one embodiment, the CBDZ program 150 may compare the context of the text block with the ROIs in the at least one frame of the video content to determine the most relevant region of the at least one frame, as described previously with reference to FIG. 2.

According to at least one embodiment, the CBDZ program 150 may use the keywords candidates as a specification of characteristics (e.g., color, shape, size, texture, action) to look for when searching for the ROIs in the frames of the video content. According to one embodiment, the CBDZ program 150 may determine which keyword candidates corresponds to each of the detected ROIs. Then, the CBDZ program 150 may correlate (e.g., assign; link) each of the ROIs with the relevance scores of the keyword candidates that corresponds to the ROI.

According to one embodiment, the CBDZ program 150 may select a subset of ROIs that corresponds to the subset of keywords. Since the subset of keywords includes the highest ranking set of the relevance scores, the CBDZ program 150 may correlate the subset of the ROIs corresponding to the subset of keywords with the highest ranking set of the relevance scores. In other words, the CBDZ program 150 may filter the set of ROIs to select the subset of the ROIs corresponding to the subset of keywords having the highest ranking set of the relevance scores.

In another embodiment, the CBDZ program 150 may only use the subset of keywords (e.g., instead of all the keyword candidates) as the specification of characteristics to look for when searching for the ROIs in the frames of the video content. As such, the ROIs detected based on instructions to search for characteristics of the subset of keywords, may be correlated with the highest ranking set of the relevance scores assigned to the corresponding subset of keywords.

According to one embodiment, once the CBDZ program 150 selects the subset of ROIs associated with the highest ranking set of the relevance scores, the CBDZ program 150 may determine a greatest common area in the frame that captures the subset of ROIs. In one embodiment, the CBDZ program 150 may identify the determined greatest common area in the frame as the most relevant region of the frame. In one embodiment, the CBDZ program 150 may determine one or more coordinates of the most relevant region in the frame. In one embodiment, the coordinates may provide a bounding box to locate the most relevant region in the frame of the video content.

Then at 308, the most relevant region of the at least one frame is stored as a zoom region of the at least one frame. According to one embodiment, the CBDZ program 150 may store (e.g., register; save) the most relevant region (e.g., coordinates of the most relevant region) as a zoom region associated with the frame. In one embodiment, the CBDZ program 150 may store the zoom region per frame for the entire video content. In some embodiments, the CBDZ program 150 may store the zoom region per clip for the entire video content such that each of the at least one frames in the clip may include the same zoom region. The CBDZ program 150 may store a respective most relevant region (e.g., using the coordinates of the most relevant region) of the plurality of frames of the video content as a set of zooming instructions for the video content. The set of zooming instructions may indicate a respective zoom region of the plurality of frames of the video content. The set of zooming instructions may provide a viewing pattern (e.g., zooming pattern) synced to the video content. In one embodiment, the viewing pattern may indicate whether to zoom into a given frame and if so, what region of the frame to zoom into.

Thereafter at 310, in response to displaying the at least one frame of the video content, the zoom region of the at least one frame is dynamically magnified. According to one embodiment, the CBDZ program 150 may transmit (e.g., broadcast) the video content with the set of zooming instructions to a user device (e.g., EUD 103). In one embodiment, the CBDZ program 150 may detect a selection of a zoom-to-context (e.g., zoom to action) option on the user device. In response to detecting the selection, the CBDZ program 150 may initiate the set of zooming instructions (e.g., viewing pattern) for the video content.

In one embodiment, the CBDZ program 150 may output a dynamically zoomed video content on the user device (e.g., display on user device screen). In one embodiment, the CBDZ program 150 may enable the dynamically zoomed video content to detect the specific frame of the video content being displayed on the user device. In response to the detection, the CBDZ program 150 dynamically magnify (e.g., zoom into) the respective zoom region of the detected specific frame of the video content.

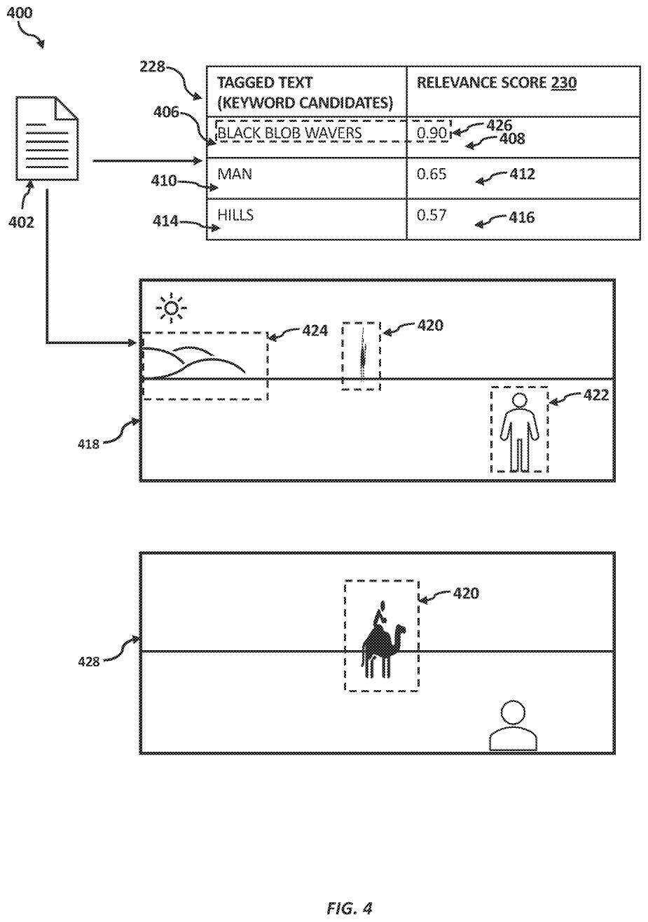

Referring now to FIG. 4, a schematic block diagram illustrating an example 400 implementing the process 300 used by the CBDZ program 150 in the video enhancement environment 200 according to at least one embodiment is depicted.

According to one embodiment, the CBDZ program 150 may receive a scene 402 from a script (e.g., text block 222 of text document 218) for analysis and context determination using natural language processing (NLP). In one embodiment, the CBDZ program 150 may generate a list or set of keyword candidates 228 (e.g., tagged text) ranked by respective relevance scores 230, as described previously with reference to FIGS. 2 and 3. In example 400, the CBDZ program 150 may output a first keyword candidate 406, “black blob wavers” with a first relevance score 408 of 0.90, a second keyword candidate 410, “man” with a second relevance score 412 of 0.65, and a third keyword candidate 414, “hills” with a third relevance score 416 of 0.57.

According to one embodiment, the CBDZ program 150 may identify a first frame 418 (e.g., frame 224) as being synced to the scene 402. In one embodiment, the CBDZ program 150 may process the first frame 418 using image segmentation techniques to search for specific regions of interest (ROIs) 236 corresponding to the characteristics specified by the keyword candidates 406, 410, 414 (e.g., tagged text).

In one embodiment, the CBDZ program 150 may detect a first ROI 420 (e.g., ROI 236) corresponding to the first keyword candidate 406 (“black blob wavers”), a second ROI 422 corresponding the second keyword candidate 410 (“man”), a third ROI 424 corresponding to the third keyword candidate 414 (“hills”).

According to one embodiment, the CBDZ program 150 may filter the detected ROIs 420, 422, 424 to select the first ROI 420 corresponding to a tagged text of highest relevance 426. In one embodiment, the tagged text of highest relevance 426 may include the keyword 232 selected from the keyword candidates 228 for having the highest ranking relevance score 230. In example 400, the CBDZ program 150 may select the first keyword candidate 406 (“black blob wavers”) as the keyword 232 since the first relevance score 408 of 0.90 is the highest ranking relevance score 230 in the set of relevance scores. In one embodiment, the CBDZ program 150 may be able to recognize the presence of the “black blob” (e.g., by detecting a cluster of black pixels) in the first frame 418 and may mark that region as the first ROI 420. After determining that the first ROI 420 correlates to the tagged text of highest relevance 426, the CBDZ program 150 may identify the first ROI 420 as the most relevant region 238 and the zoom region 242 of the first frame 418.

According to one embodiment, when a user device (e.g., EUD 103) selects the zoom-to-context option of the CBDZ program 150, the CBDZ program 150 may display an enhanced first frame 428 corresponding to the first frame 418. In one embodiment, the enhanced first frame 428 may be provided in the dynamically zoomed video content 246, as described previously with reference to FIG. 2. In example 400, the CBDZ program 150 may dynamically magnify or zoom into the first ROI 420 as being the most relevant region 238 (e.g., zoom region 242) in the enhanced first frame 428. As illustrated in FIG. 4, the CBDZ program 150 may crop out all or most of the other areas of the enhanced first frame 428 to help the user (e.g., with visual impairments) to focus on the first ROI 420 (e.g., most relevant region 238) based on the context of the scene 402.

It is contemplated that the CBDZ program 150 may provide several advantages and/or improvements to the technical field of user accessibility. The CBDZ program 150 may also improve the functionality of a computer because the CBDZ program 150 may enable the computer to perform context-driven image segmentation, where the context is determined from a text document associated with the image (e.g., frame). Thus, the CBDZ program 150 may improve the functionality of the computer by enabling the computer to combine the context from the text document, with image segmentation techniques, to identify the most relevant regions in the image.

It may be appreciated that FIGS. 2 to 4 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining a context of a text block using natural language processing (NLP);
identifying a clip of a video content synced with the text block, wherein the clip includes at least one frame of the video content;
selecting a most relevant region of the at least one frame of the video content based on the context of the text block;
storing the most relevant region of the at least one frame of the video content as a zoom region of the at least one frame; and
in response to displaying the at least one frame of the video content, dynamically magnifying the zoom region of the at least one frame of the video content.

2. The computer-implemented method of claim 1, further comprising:
detecting, using image segmentation, at least one region of interest (ROI) in the at least one frame of the video content; and
comparing the context of the text block with the at least one ROI in the at least one frame to determine the most relevant region of the at least one frame, wherein the most relevant region of the at least one frame visually represents the context of the text block.

3. The computer-implemented method of claim 1, wherein determining the context of the text block using NLP further comprises:
extracting a set of keyword candidates from the text block;
ranking the set of keyword candidates based on a relevance score assigned to each keyword candidate, respectively, of the set of keyword candidates, wherein the relevance score assigned to each keyword candidate indicates a relative importance of each keyword candidate to understanding the context of the text block; and
selecting a subset of keywords from the set of keyword candidates based on the subset of keywords having a highest ranking set of the relevance scores, wherein the subset of keywords indicates the context of the text block.

4. The computer-implemented method of claim 3, further comprising:
detecting, using image segmentation, a set of regions of interest (ROIs) in the at least one frame of the video content corresponding to the set of keyword candidates extracted from the text block; and
selecting, from the set of ROIs, a subset of ROIs corresponding to the subset of keywords having the highest ranking set of the relevance scores such that the subset of ROIs are associated with the highest ranking set of the relevance scores.

5. The computer-implemented method of claim 4, further comprising:
determining a greatest common area in the at least one frame of the video content that captures the subset of ROIs;
identifying the greatest common area as the most relevant region of the at least one frame of the video content; and
storing a set of coordinates of the most relevant region as the zoom region of the at least one frame of the video content.

6. The computer-implemented method of claim 1, wherein storing the most relevant region of the at least one frame of the video content as the zoom region of the at least one frame further comprises:
storing a respective most relevant region of a plurality of frames of the video content as a set of zooming instructions for the video content, wherein the set of zooming instructions indicates a respective zoom region of the plurality of frames of the video content.

7. The computer-implemented method of claim 6, further comprising:
broadcasting the video content with the set of zooming instructions to a user device;
in response to detecting a selection of a zoom-to-context option on the user device, initiating the set of zooming instructions for the video content; and
dynamically magnifying the respective zoom region of the plurality of frames of the video content.

8. A computer system for context-based dynamic zooming, comprising:
one or more processors, one or more computer-readable memories and one or more computer-readable storage media;
program instructions, stored on at least one of the one or more storage media for execution by at least one of the one or more processors via at least one of the one or more memories, to determine a context of a text block using natural language processing (NLP);
program instructions, stored on at least one of the one or more storage media for execution by at least one of the one or more processors via at least one of the one or more memories, to identify a clip of a video content synced with the text block, wherein the clip includes at least one frame of the video content;
program instructions, stored on at least one of the one or more storage media for execution by at least one of the one or more processors via at least one of the one or more memories, to select a most relevant region of the at least one frame of the video content based on the context of the text block;
program instructions, stored on at least one of the one or more storage media for execution by at least one of the one or more processors via at least one of the one or more memories, to store the most relevant region of the at least one frame of the video content as a zoom region of the at least one frame; and
program instructions, stored on at least one of the one or more storage media for execution by at least one of the one or more processors via at least one of the one or more memories, to in response to displaying the at least one frame of the video content, dynamically magnify the zoom region of the at least one frame of the video content.

9. The computer system of claim 8, further comprising:
program instructions, stored on at least one of the one or more storage media for execution by at least one of the one or more processors via at least one of the one or more memories, to detect, using image segmentation, at least one region of interest (ROI) in the at least one frame of the video content; and
program instructions, stored on at least one of the one or more storage media for execution by at least one of the one or more processors via at least one of the one or more memories, to compare the context of the text block with the at least one ROI in the at least one frame to determine the most relevant region of the at least one frame, wherein the most relevant region of the at least one frame visually represents the context of the text block.

10. The computer system of claim 8, wherein:
the program instructions to determine the context of the text block using NLP further comprises:
program instructions, stored on at least one of the one or more storage media for execution by at least one of the one or more processors via at least one of the one or more memories, to extract a set of keyword candidates from the text block;
program instructions, stored on at least one of the one or more storage media for execution by at least one of the one or more processors via at least one of the one or more memories, to rank the set of keyword candidates based on a relevance score assigned to each keyword candidate, respectively, of the set of keyword candidates, wherein the relevance score assigned to each keyword candidate indicates a relative importance of each keyword candidate to understanding the context of the text block; and
program instructions, stored on at least one of the one or more storage media for execution by at least one of the one or more processors via at least one of the one or more memories, to select a subset of keywords from the set of keyword candidates based on the subset of keywords having a highest ranking set of the relevance scores, wherein the subset of keywords indicates the context of the text block.

11. The computer system of claim 10, further comprising:
program instructions, stored on at least one of the one or more storage media for execution by at least one of the one or more processors via at least one of the one or more memories, to detect, using image segmentation, a set of regions of interest (ROIs) in the at least one frame of the video content corresponding to the set of keyword candidates extracted from the text block; and
program instructions, stored on at least one of the one or more storage media for execution by at least one of the one or more processors via at least one of the one or more memories, to select, from the set of ROIs, a subset of ROIs corresponding to the subset of keywords having the highest ranking set of the relevance scores such that the subset of ROIs are associated with the highest ranking set of the relevance scores.

12. The computer system of claim 11, further comprising:
program instructions, stored on at least one of the one or more storage media for execution by at least one of the one or more processors via at least one of the one or more memories, to determine a greatest common area in the at least one frame of the video content that captures the subset of ROIs;
program instructions, stored on at least one of the one or more storage media for execution by at least one of the one or more processors via at least one of the one or more memories, to identify the greatest common area as the most relevant region of the at least one frame of the video content; and
program instructions, stored on at least one of the one or more storage media for execution by at least one of the one or more processors via at least one of the one or more memories, to store a set of coordinates of the most relevant region as the zoom region of the at least one frame of the video content.

13. The computer system of claim 8, wherein:
the program instructions to store the most relevant region of the at least one frame of the video content as the zoom region of the at least one frame further comprises:
program instructions, stored on at least one of the one or more storage media for execution by at least one of the one or more processors via at least one of the one or more memories, to store a respective most relevant region of a plurality of frames of the video content as a set of zooming instructions for the video content, wherein the set of zooming instructions indicates a respective zoom region of the plurality of frames of the video content.

14. The computer system of claim 13, further comprising:
program instructions, stored on at least one of the one or more storage media for execution by at least one of the one or more processors via at least one of the one or more memories, to broadcast the video content with the set of zooming instructions to a user device;
program instructions, stored on at least one of the one or more storage media for execution by at least one of the one or more processors via at least one of the one or more memories, to in response to detecting a selection of a zoom-to-context option on the user device, initiate the set of zooming instructions for the video content; and
program instructions, stored on at least one of the one or more storage media for execution by at least one of the one or more processors via at least one of the one or more memories, to dynamically magnify the respective zoom region of the plurality of frames of the video content.

15. A computer program product for context-based dynamic zooming, the computer program product comprising:
one or more computer-readable storage media;
program instructions, stored on at least one of the one or more storage media, to determine a context of a text block using natural language processing (NLP);
program instructions, stored on at least one of the one or more storage media, to identify a clip of a video content synced with the text block, wherein the clip includes at least one frame of the video content.;
program instructions, stored on at least one of the one or more storage media, to select a most relevant region of the at least one frame of the video content based on the context of the text block;
program instructions, stored on at least one of the one or more storage media, to store the most relevant region of the at least one frame of the video content as a zoom region of the at least one frame; and
program instructions, stored on at least one of the one or more storage media, to in response to displaying the at least one frame of the video content, dynamically magnify the zoom region of the at least one frame of the video content.

16. The computer program product of claim 15, further comprising:
program instructions, stored on at least one of the one or more storage media, to detect, using image segmentation, at least one region of interest (ROI) in the at least one frame of the video content; and
program instructions, stored on at least one of the one or more storage media, to compare the context of the text block with the at least one ROI in the at least one frame to determine the most relevant region of the at least one frame, wherein the most relevant region of the at least one frame visually represents the context of the text block.

17. The computer program product of claim 15, wherein:
the program instructions to determine the context of the text block using NLP further comprises:
program instructions, stored on at least one of the one or more storage media, to extract a set of keyword candidates from the text block;
program instructions, stored on at least one of the one or more storage media, to rank the set of keyword candidates based on a relevance score assigned to each keyword candidate, respectively, of the set of keyword candidates, wherein the relevance score assigned to each keyword candidate indicates a relative importance of each keyword candidate to understanding the context of the text block; and
program instructions, stored on at least one of the one or more storage media, to select a subset of keywords from the set of keyword candidates based on the subset of keywords having a highest ranking set of the relevance scores, wherein the subset of keywords indicates the context of the text block.

18. The computer program product of claim 17, further comprising:
program instructions, stored on at least one of the one or more storage media, to detect, using image segmentation, a set of regions of interest (ROIs) in the at least one frame of the video content corresponding to the set of keyword candidates extracted from the text block; and
program instructions, stored on at least one of the one or more storage media, to select, from the set of ROIs, a subset of ROIs corresponding to the subset of keywords having the highest ranking set of the relevance scores such that the subset of ROIs are associated with the highest ranking set of the relevance scores.

19. The computer program product of claim 18, further comprising:
program instructions, stored on at least one of the one or more storage media, to determine a greatest common area in the at least one frame of the video content that captures the subset of ROIs;
program instructions, stored on at least one of the one or more storage media, to identify the greatest common area as the most relevant region of the at least one frame of the video content; and
program instructions, stored on at least one of the one or more storage media, to store a set of coordinates of the most relevant region as the zoom region of the at least one frame of the video content.

20. The computer program product of claim 15, wherein:
the program instructions to store the most relevant region of the at least one frame of the video content as the zoom region of the at least one frame further comprises:
program instructions, stored on at least one of the one or more storage media, to store a respective most relevant region of a plurality of frames of the video content as a set of zooming instructions for the video content, wherein the set of zooming instructions indicates a respective zoom region of the plurality of frames of the video content.
